(19) United States
(12) Patent Application Publication
(10) Pub. No.: US 2010/0123382 A1
(43) Pub. Date: May 20, 2010

(54) Field emission cathode plate and method for fabricating the same

(75) Inventors: Hung-Yuan Li, Taipei (TW); Jian-Min Jeng, Taipei (TW); Ching-Hsuang Cheng, Taipei (TW); Nien-Chun Chin, Taipei (TW); Tzung-Han Yang, Taipei (TW)

Correspondence Address: BACON & THOMAS, PLLC, 625 SLATERS LANE, FOURTH FLOOR, ALEXANDRIA, VA, 22314-1176, US

(73) Assignees: Tatung Company, Taipei (TW); Industrial Technology Research Institute, Chutung (TW)

(21) Appl. No.: 12/385,890

(22) Filed: Apr. 23, 2009

(30) Foreign Application Priority Data
Nov. 14, 2008 (TW) 097144249

(51) Int. Cl. H01J 1/14; H01J 9/04

(52) U.S. Cl. 313/346 R; 445/51

(57) ABSTRACT

A field emission cathode plate is disclosed, which includes: a substrate; a cathode layer, disposed on the substrate; a conductive layer with an arc surface or a resistor layer with an opening and resistivity larger than that of the cathode layer, disposed on the cathode layer; and a cambered field emission layer, having an arc surface and disposed on the conductive layer or on the cathode layer in the opening of the resistor layer and covering the resistor layer around the opening. The present invention also provides a method for fabricating the above-mentioned field emission cathode plate. The method can provide field emission cathode plate achieving uniform field emission and does not involve high resolution and cost.

### BACKGROUND OF THE INVENTION

1. Field of the Invention

The present invention relates to a field emission cathode plate and a method for fabricating the same and, more particularly, to a field emission cathode plate achieving uniform field emission and a method for fabricating the same.

2. Description of Related Art

A field emission device emits electrons from a cathode emitter when an electric field is applied thereto in a vacuum or specific gas atmosphere, so that it is widely employed as an electron source of a microwave device, a sensor, a flat panel display or the like.

Electron emission efficiency from the field emission device greatly varies according to an emitter material, an emitter shape and a device structure. A field emitter material may include metal, silicon, diamond, diamond like carbon, carbon nanotubes, carbon nanofibers, and carbon nanotubes and the carbon nanofibers are widely used as the emitter material because of their thin and pointed shape and stability. A structure of the field emission device may be mainly classified into a diode type comprised of a cathode and an anode, and a triode type comprised of a cathode, a gate and an anode.

In the triode type field emission device, the cathode or the field emitter carries out a function of emitting electrons, and the gate carries out a function of inducing the electron emission, and the anode carries out a function of receiving the emitted electrons. Since the electric field for the electron emission is applied to the gate adjacent to the emitter in the triode type structure, it allows an emitting current to be readily controlled compared to the diode type, so that it is widely under development.

In the triode type field emission device, the number of field emitters per unit area is usually increased to enhance the entire field emission uniformity. For example, numerous holes are arranged in a field emission display for drawing electrons, such that sub-pixels can achieve uniform and saturated bright spots. In the case that a single hole is arranged for drawing electrons, only the field emitter adjacent to the gate can emit electrons, and thereby non-uniform field emission will occur in the field emission device. However, if numerous holes are fabricated in the case of increasing the number of field emitters, the manufacture cost will significantly increase and thus mass production is difficult.

With regard to the importance of field emission uniformity of field emission cathode plates or devices, except those other than the traditional triode type structure or those having stable a field emission cathode plate, for example, surface conduction electron emitter displays and Spindt type field emission displays, the field emission uniformity often cannot be efficiently enhanced in common field emission cathode plates due to high manufacture cost. Therefore, it is desirable to provide a method in which high cost is not required and field emission cathode plates or devices with uniform field emission can be fabricated.

### SUMMARY OF THE INVENTION

The object of the present invention is to provide a field emission cathode plate and a method for fabricating the same, in which the field emission uniformity of the resultant field emission cathode plate or the whole device thereof can be efficiently enhanced and high resolution and cost are not required.

To achieve the object, the present invention provides a field emission cathode plate, comprising: a substrate; a cathode layer, disposed on the surface of the substrate; a conductive layer with an arc surface, disposed on the surface of the cathode layer; and a field emission layer with an arc surface, disposed on the surface of the conductive layer.

The above-mentioned field emission cathode plate can further comprise an insulating layer disposed on the surface of the cathode layer, in which the insulating layer has a first opening to expose the field emission layer. Also, the field emission cathode plate can further comprise a gate layer disposed on the surface of the insulating layer, in which the gate layer has a second opening corresponding to the first opening to expose the field emission layer.

In addition, the present invention further provides a method for fabricating the above-mentioned field emission cathode plate, comprising: providing a substrate; forming a cathode layer on the surface of the substrate; forming a conductive layer on the surface of the cathode layer, in which the conductive layer has an arc surface; and forming a field emission layer on the conductive layer, in which the field emission layer has an arc surface.

The method for fabricating the above-mentioned field emission cathode plate can further comprise: forming an insulating layer on the surface of the cathode layer, in which the insulating layer has a first opening to expose the field emission layer. Also, the above-mentioned method can further comprise: forming a gate layer on the surface of the insulating layer, in which the gate layer has a second opening corresponding to the first opening to expose the field emission layer.

In the above-mentioned field emission cathode plate and the method for fabricating the same, the field emission layer can cover the conductive layer overall, and the material of the field emission layer is selected from the group consisting of carbon nanotubes, graphite, carbon nanofibers, carbon nanocapsules, diamond-like carbon, molybdenum, silicon carbide and zinc oxide.

In the above-mentioned cases, a conductive layer is formed as a drop-like pattern with an arc surface on the surface of the cathode layer in the first opening of the insulating layer by screen printing, and then a field emission layer is formed on the drop-like conductive layer. Accordingly, the center of the field emission layer is higher than the bottom edge thereof, such that the distance between the center of the field emission layer and the gate layer more approximates that between the bottom edge of the field emission layer and the gate layer. Thereby, when an electric field is applied to the gate layer, electrons can be drawn uniformly from the field emission layer so as to enhance the field emission uniformity.

The present invention further provides a field emission cathode plate, comprising: a substrate; a cathode layer, disposed on the surface of the substrate; a resistor layer having an opening, disposed on the surface of the cathode layer, wherein the resistor layer has resistivity larger than that of the cathode layer; and a field emission layer, disposed on the surface of the cathode layer in the opening of the resistor layer and covering the resistor layer around the opening.

The above-mentioned field emission cathode plate can further comprise an insulating layer on the surface of the cathode layer, in which the insulating layer has a first opening to expose the field emission layer. Also, the above-mentioned field emission cathode plate can further comprise a gate layer disposed on the surface of the insulating layer, wherein the gate layer has a second opening corresponding to the first opening to expose the field emission layer.

In addition, the present invention provides a method for fabricating the above-mentioned field emission cathode plate, comprising: providing a substrate; forming a cathode layer on the surface of the substrate; forming a resistor layer on the surface of the cathode layer, in which the resistor layer has an opening and the resistor layer has resistivity larger than that of the cathode layer; and forming a field emission layer on the surface of the cathode layer in the opening of the resistor layer, in which the field emission layer covers the resistor layer around the opening.

The method for fabricating the above-mentioned field emission cathode plate can further comprise: forming an insulating layer on the surface of the cathode layer, in which the insulating layer has a first opening to expose the field emission layer. Also, the above-mentioned method can further comprise: forming a gate layer on the surface of the insulating layer, in which the gate layer has a second opening corresponding to the first opening to expose the field emission layer.

In the above-mentioned field emission cathode plate and the method for fabricating the same, the thickness of the field emission layer in the opening of the resistor layer can be larger than that of the resistor layer, and the resistivity of the resistor layer can range from 10⁴ to 10¹⁰ Ω·M. Additionally, the material of the field emission layer is selected from the group consisting of carbon nanotubes, graphite, carbon nanofibers, carbon nanocapsules, diamond-like carbon, molybdenum, silicon carbide and zinc oxide.

In the above-mentioned cases, a material with higher resistivity is used as a resistor layer, in which the resistor layer having an opening in the center thereof is formed on the surface of the cathode layer in the first opening of the insulating layer by a patterning process, and a field emission layer is formed on the surface of the cathode layer in the opening of the resistor layer and covers the resistor layer around the opening. Accordingly, in order to draw electrons, the edge of the field emission layer adjacent to the gate layer needs a higher electric field applied thereon due to the resistor layer under the edge of the field emission layer has high resistivity. On the other hand, under the higher electric field, electrons also can be drawn from the far center of the field emission layer with respect to the gate layer because there is no resistor layer with high resistivity under the center of the field emission layer. Thereby, the excellent field emission uniformity can be achieved.

In conclusion, the present invention uses a simple method to fabricate field emission cathode plates with improved field emission uniformity, and thereby the problems occurring in the prior art (that is, high costs incurred in enhancing field emission uniformity) can be resolved.

Other objects, advantages, and novel features of the invention will become more apparent from the following detailed description when taken in conjunction with the accompanying drawings.

### BRIEF DESCRIPTION OF THE DRAWINGS

FIGS. 1A to 1F are cross-sectional views for showing a process for fabricating a field emission cathode plate according to Example 1 of the present invention;

FIGS. 2A to 2D are cross-sectional views for showing a process for fabricating a field emission cathode plate according to Example 2 of the present invention;

FIGS. 3A to 3E are cross-sectional views for showing a process for fabricating a field emission cathode plate according to Example 3 of the present invention; and

FIGS. 4A to 4D are cross-sectional views for showing a process for fabricating a field emission cathode plate according to Example 4 of the present invention.

### DETAILED DESCRIPTION OF THE PREFERRED EMBODIMENT

Because of the specific embodiments illustrating the practice of the present invention, a person having ordinary skill in the art can easily understand other advantages and efficiency of the present invention through the content disclosed therein. The present invention can also be practiced or applied by other variant embodiments. Many other possible modifications and variations of any detail in the present specification based on different outlooks and applications can be made without departing from the spirit of the invention.

The drawings of the embodiments in the present invention are all simplified charts or views, and only reveal elements relative to the present invention. The elements revealed in the drawings are not necessarily aspects of the practice, and quantity and shape thereof are optionally designed. Further, the design aspect of the elements can be more complex.

### EXAMPLE 1

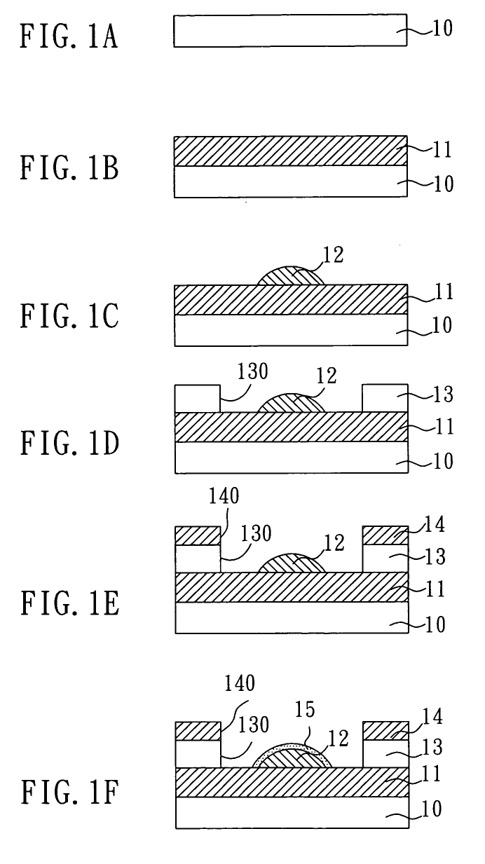

With reference to FIGS. 1A to 1F, there are cross-sectional views for showing a process for fabricating a field emission cathode plate according to the present embodiment of the present invention.

As shown in FIG. 1A, a substrate 10 is first provided. Herein, the substrate of the present invention can be any suitable substrate in the art. In the present embodiment, a glass substrate is used.

Subsequently, as shown in FIG. 1B, silver paste is applied on the surface of the substrate 10 to form a cathode layer 11 via screen printing. Herein, the material of the cathode layer 11 according to the present invention can be any conventional material, and is not limited to silver used in the present embodiment.

As shown in FIG. 1C, a drop of silver paste is screen printed on the surface of the cathode layer 11 to form a conductive layer 12 with an arc surface. For example, the center of the conductive layer 12 with the maximum thickness can be as thick as about 3-10 μm, and the diameter of the conductive layer 12 can be about 140-160 μm. Herein, the conductive layer 12 of the present invention can be made of any conventional material, such as a material identical to or different from that of the cathode layer 11, not limited to silver used in the present embodiment.

Then, as shown in FIG. 1D, glass is screen printed on the surface of the cathode layer 11 to form an insulating layer 13. The insulating layer 13 has a first opening 130 to expose the conductive layer 12. For example, the thickness of the insulating layer 13 can be about 1-30 μm, and the diameter of the first opening 130 can be about 230-250 μm.

As shown in FIG. 1E, silver paste is screen printed on the surface of the insulating layer 13 to form a gate layer 14. The gate layer 14 has a second opening 140 corresponding to the first opening 130 to expose the conductive layer 12. The diameter of the second opening 140 can be about 230-300 μm.

Finally, as shown in FIG. 1F, carbon nanotubes are screen printed on the surface of the conductive layer 12 to form a field emission layer 15 covering the conductive layer 12 overall, such that a field emission cathode plate is provided. For example, the diameter of the field emission layer 15 can be about 170-190 μm. Herein, the material of the field emission layer 15 is not limited to carbon nanotubes, and can be graphite, carbon nanofibers, carbon nanocapsules, diamond-like carbon, molybdenum, silicon carbide, zinc oxide or other materials suitable for field emission.

The field emission cathode plate includes: a substrate 10; a cathode layer 11, disposed on the surface of the substrate 10; a conductive layer 12 with an arc surface, disposed on the surface of the cathode layer 11; a field emission layer 15 with an arc surface, covering the surface of the conductive layer 12 overall; an insulating layer 13, disposed on the cathode layer 11, in which the insulating layer 13 has a first opening 130 to expose the field emission layer 15; and a gate layer 14, disposed on the surface of the insulating layer 13, in which the gate layer 14 has a second opening 140 corresponding to the first opening 130 to expose the field emission layer 15.

### EXAMPLE 2

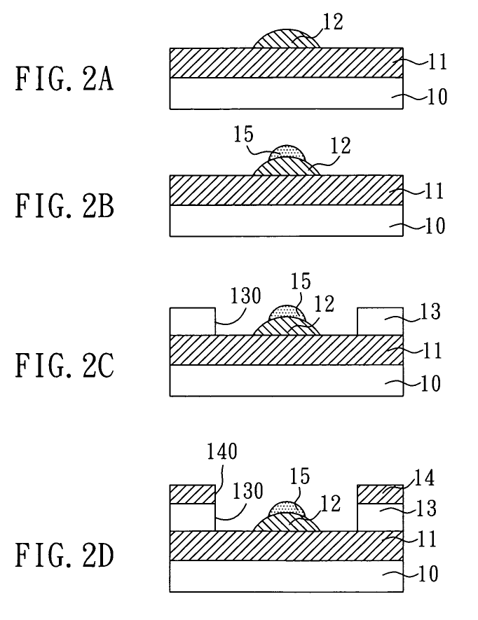

With reference to FIGS. 2A to 2D, there are cross-sectional views for showing a process for fabricating a field emission cathode plate according to the present embodiment of the present invention. The process according to the present embodiment is the same as that described in Example 1, except that the sequence of steps for forming elements is different from that described in Example 1.

According to FIGS. 1A to 1C, a cathode layer 11 is formed on the surface of the substrate 10, and a conductive layer 12 is formed on the surface of the cathode layer 11, so as to obtain the structure as shown in FIG. 2A.

Subsequently, as shown in FIG. 2B, carbon nanotubes are screen printed on the surface of the conductive layer 12 to form a field emission layer 15 with an arc surface on the center surface of the conductive layer 12.

As shown in FIG. 2C, an insulating layer 13 is formed on the surface of the cathode layer 11. Herein, the insulating layer 13 has a first opening 130 to expose the conductive layer 12.

Finally, as shown in FIG. 2D, a gate layer 14 is formed on the surface of the insulating layer 13, and the gate layer 14 has a second opening 140 corresponding to the first opening 140 to expose the conductive layer 12. Accordingly, a field emission cathode plate is provided.

In view of the above-mentioned illustration, it can be known that Examples 1 and 2 utilize the arc surface of the conductive layer to form a field emission layer with an arc surface. Accordingly, the center of the field emission layer is higher than the bottom edge thereof, such that the distance between the center of the field emission layer and the gate layer more approximates that between the bottom edge of the field emission layer and the gate layer. Thereby, when an electric field is applied to the gate layer, electrons can be drawn uniformly from the field emission layer so as to enhance the field emission uniformity.

### EXAMPLE 3

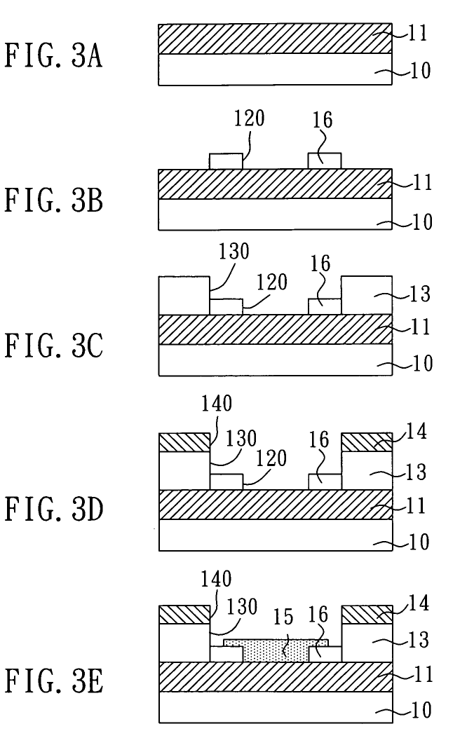

With reference to FIGS. 3A to 3E, there are cross-sectional views for showing a process for fabricating a field emission cathode plate according to the present embodiment of the present invention.

According to FIGS. 1A to 1B, a cathode layer 11 is first formed on the surface of the substrate 10 to obtain the structure as shown in FIG. 3A. However, in the present embodiment, the cathode layer 11 is formed by sputtering gold on the surface of the surface 10 rather than the screen printing used in Example 1.

Subsequently, as shown in FIG. 3B, a resistor layer 16 made of chromium is formed on the surface of the cathode layer 11 by a patterning process, in which the resistor layer 16 has an opening 120. Herein, the material of the resistor layer 16 is not limited to chromium as long as the resistivity of the resistor layer 16 is larger than that of the cathode layer 11. For example, the resistor layer 16 can be made of a material with resistivity ranging from 10⁴ to 10¹⁰ Ωm and has a thickness of about 1-5 μm, and the diameter of the opening 120 can be about 140-160 μm.

As shown in FIG. 3C, an SiO₂ film is formed on the surface of the cathode layer 11 as an insulating layer 13. The insulating layer 13 has a first opening 130 corresponding to opening 120 to expose the resistor layer 16.

Next, as shown in FIG. 3D, a gold film is formed on the surface of the insulating layer 13 as a gate layer 14. The gate layer 14 has a second opening 140 corresponding to the first opening 130 to expose the resistor layer 16.

Finally, as shown in FIG. 3E, carbon nanotubes are screen printed on the surface of the cathode layer 11 to form a field emission layer 15 covering the resistor layer 16. Accordingly, a field emission cathode plate is provided.

The field emission cathode plate includes: a substrate 10; a cathode layer 11, disposed on the surface of the substrate 10; a resistor layer 16, disposed on the surface of the cathode layer 1 1 and having an opening 120, in which resistivity of the resistor layer 16 is larger than that of the cathode layer 11; a field emission layer 15, disposed on the surface of the conductive layer 12 in the opening 120 of the resistor layer 16 and covering the resistor layer 16 around the opening 120; an insulating layer 13, disposed on the cathode layer 11, in which the insulating layer 13 has a first opening 130 to expose the field emission layer 15; and a gate layer 14, disposed on the surface of the insulating layer 13, in which the gate layer 14 has a second opening 140 corresponding to the first opening 130 to expose the field emission layer 15.

### EXAMPLE 4

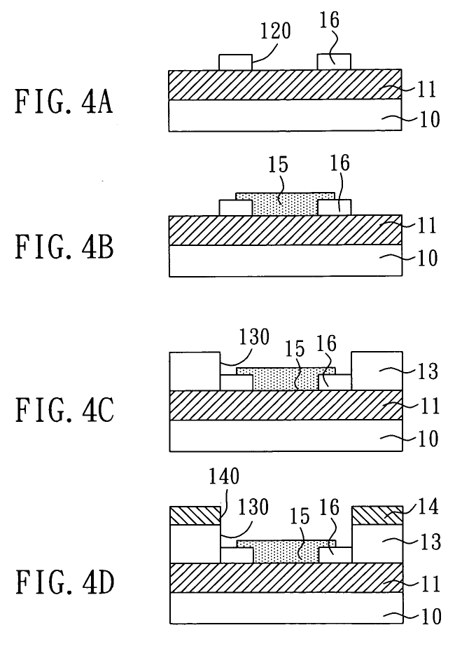

With reference to FIGS. 4A to 4D, there are cross-sectional views for showing a process for fabricating a field emission cathode plate according to the present embodiment of the present invention. The process according to the present embodiment is the same as that described in Example 3, except that the sequence of steps for forming elements is different from that described in Example 3.

According to FIGS. 3A to 3B in Example 3, a cathode layer 11 is formed on the surface of the substrate 10, and a resistor layer 16 is formed on the surface of the cathode layer 11, so as to obtain the structure as shown in FIG. 4A.

Subsequently, as shown in FIG. 4B, carbon nanotubes are screen printed on the surface of the cathode layer 11 to form a field emission layer 15 in the opening 120 of the resistor layer 16 and over the resistor layer 16 around the opening 120.

As shown in FIG. 4C, an insulating layer 13 is formed on the surface of the cathode layer 11. The insulating layer 13 has a first opening 130 to expose the resistor layer 16.

Finally, as shown in FIG. 4D, a gate layer 14 is formed on the surface of the insulating layer 13. The gate layer 14 has a second opening 140 corresponding to the first opening 130 to expose the resistor layer 16.

In views of the above-mentioned illustration, it can be known that Examples 3 and 4 use a material with higher resistivity as a resistor layer. Accordingly, in order to draw electrons, the edge of the field emission layer adjacent to the gate layer needs a higher electric field applied thereon due to the resistor layer under the edge of the field emission layer has high resistivity. In the higher electric field, electrons also can be drawn from the far center of the field emission layer with respect to the gate layer, and thereby the center and the edge of the field emission layer simultaneously emit electrons to achieve excellent field emission uniformity.

Although the present invention has been explained in relation to its preferred embodiment, it is to be understood that many other possible modifications and variations can be made without departing from the scope of the invention as hereinafter claimed.

What is claimed is:

1. A field emission cathode plate, comprising:
a substrate;
a cathode layer, disposed on the surface of the substrate;
a conductive layer with an arc surface, disposed on the surface of the cathode layer; and
a field emission layer with an arc surface, disposed on the surface of the conductive layer.

2. The field emission cathode plate as claimed in claim 1, further comprising: an insulating layer disposed on the surface of the cathode layer, wherein the insulating layer has a first opening to expose the field emission layer.

3. The field emission cathode plate as claimed in claim 2, further comprising: a gate layer disposed on the surface of the insulating layer, wherein the gate layer has a second opening corresponding to the first opening to expose the field emission layer.

4. The field emission cathode plate as claimed in claim 1, wherein the field emission layer covers the conductive layer overall.

5. The field emission cathode plate as claimed in claim 1, wherein the material of the field emission layer is selected from the group consisting of carbon nanotubes, graphite, carbon nanofibers, carbon nanocapsules, diamond-like carbon, molybdenum, silicon carbide and zinc oxide.

6. A method for fabricating a field emission cathode plate, comprising:
providing a substrate;
forming a cathode layer on the surface of the substrate;
forming a conductive layer on the surface of the cathode layer, wherein the conductive layer has an arc surface; and
forming a field emission layer on the conductive layer, wherein the field emission layer has an arc surface.

7. The method as claimed in claim 6, further comprising: forming an insulating layer on the surface of the cathode layer, wherein the insulating layer has a first opening to expose the field emission layer.

8. The method as claimed in claim 7, further comprising: forming a gate layer on the surface of the insulating layer, wherein the gate layer has a second opening corresponding to the first opening to expose the field emission layer.

9. The method as claimed in claim 6, wherein the field emission layer covers the conductive layer overall.

10. A field emission cathode plate, comprising:
a substrate;
a cathode layer, disposed on the surface of the substrate;
a resistor layer having an opening, disposed on the surface of the cathode layer, wherein the resistor layer has resistivity larger than that of the cathode layer; and
a field emission layer, disposed on the surface of the cathode layer in the opening of the resistor layer and covering the resistor layer around the opening.

11. The field emission cathode plate as claimed in claim 10, wherein the thickness of the field emission layer in the opening of the resistor layer is larger than that of the resistor layer.

12. The field emission cathode plate as claimed in claim 10, further comprising: an insulating layer on the surface of the cathode layer, wherein the insulating layer has a first opening to expose the field emission layer.

13. The field emission cathode plate as claimed in claim 12, further comprising: a gate layer disposed on the surface of the insulating layer, wherein the gate layer has a second opening corresponding to the first opening to expose the field emission layer.

14. The field emission cathode plate as claimed in claim 12, wherein the resistor layer has resistivity ranging from 10⁴ to 10¹⁰ Ω·M.

15. The field emission cathode plate as claimed in claim 10, wherein the material of the field emission layer is selected from the group consisting of carbon nanotubes, graphite, carbon nanofibers, carbon nanocapsules, diamond-like carbon, molybdenum, silicon carbide and zinc oxide.

16. A method for fabricating a field emission cathode plate, comprising:
providing a substrate;
forming a cathode layer on the surface of the substrate;
forming a resistor layer on the surface of the cathode layer, wherein the resistor layer has an opening and the resistor layer has resistivity larger than that of the cathode layer; and
forming a field emission layer on the surface of the cathode layer in the opening of the resistor layer, wherein the field emission layer covers the resistor layer around the opening.

17. The method as claimed in claim 16, wherein the thickness of the field emission layer in the opening of the resistor layer is larger than that of the resistor layer.

18. The method as claimed in claim 16, further comprising: forming an insulating layer on the surface of the cathode layer, wherein the insulating layer has a first opening to expose the field emission layer.

19. The method as claimed in claim 18, further comprising: forming a gate layer on the surface of the insulating layer, wherein the gate layer has a second opening corresponding to the first opening to expose the field emission layer.

20. The method as claimed in claim 20, wherein the resistor layer has resistivity ranging from 10⁴ to 10¹⁰ Ω·M.
